(19) United States
(12) Patent Application Publication
(10) Pub. No.: US 2018/0206468 A1
(43) Pub. Date: Jul. 26, 2018

(54) METHOD FOR MANUFACTURING GRAPHITE SHAFT

(71) Applicant: Jung Soo LIM, Gyeonggi-do (KR)

(72) Inventor: Jung Soo LIM, Gyeonggi-do (KR)

(21) Appl. No.: 15/746,078

(22) PCT Filed: Jul. 25, 2016
(86) PCT No.: PCT/KR2016/007929

§ 371 Date: Jan. 19, 2018

(30) Foreign Application Priority Data
Jul. 23, 2015 (KR) 10-2015-0104657

(51) Int. Cl. A01K 87/00; A63B 53/10; B29C 44/18

(52) U.S. Cl. CPC A01K 87/00; A63B 53/10; A63B 2102/32; A63B 2209/00; B29C 44/18

(57) ABSTRACT

A method for producing a graphite shaft comprises the steps of: preparing a tube made of a synthetic resin into which a thermosetting resin powder is put; inserting the synthetic resin tube into the finished product graphite shaft; closing an upper end of the graphite shaft; and placing the graphite shaft in a high-temperature pressurizing apparatus and then heating the same so that the thermosetting resin powder is foamed and filled in a part of the interior of the shaft.

### FIELD OF THE INVENTION

The present invention relates to a method for producing a graphite shaft, and more specifically, to a method for producing a graphite shaft having at least a part reinforced by filler. The graphite shaft produced according to the method of the present invention can be used for a golf club, a lure fishing rod or the like.

### BACKGROUND OF THE INVENTION

A golf club is generally consisted of a club head hitting a golf ball, a shaft to which a club head is attached, and a grip. Golfers usually choose a steel shaft or a graphite shaft depending on his physical condition and swing speed.

A steel-shafted golf club has a high meeting ratio with sweet spot because of its low torque at the time of swing, and thus, the directivity of the golf ball becomes excellent. However, since the steel shaft is heavy and has a low elasticity, increasing a flight distance of a golf ball is not easy without support of the physical strength of a golfer and high swing speed.

On the other hand, because a graphite-shafted golf club is light in weight and has an excellent elasticity, it is easy to take a swing and to speed up. However, the torque at the time of swing is high, and therefore, hitting the sweet spot precisely is difficult. For this reason, the graphite-shafted golf club has a problem that it has a low meeting ratio and a poor directivity of a golf ball.

As described above, the steel shaft and the graphite shaft have mutually opposite advantages and disadvantages. Many attempts have been made for developing a graphite shaft having better performance with not only high accuracy and directivity that are the advantages of the steel shaft, but also with light weight and high elasticity that are the advantages of the graphite shaft.

Korean Patent No. 10-0917289 discloses a carbon graphite shaft, which is produced by depositing chromium on the outer surface of a golf club shaft made of carbon graphite so that the shaft can have a predetermined thickness of the chromium deposition layer. The technology took the advantage of carbon graphite such as light weight and an excellent elasticity, and tried to complement the disadvantageous torque of the graphite shaft by the chromium deposition layer. However, because its manufacturing process is complicated and the deposited chromium layer is very thin, this shaft still has problems relating to the high manufacturing cost and the relatively low strength when compared to the conventional steel shaft.

Further, Korean Patent Laid-Open Publication No. 10-2008-0019516 discloses a steel shaft having a number of holes on the outer surface of the shaft along its axial direction. This invention aims to remedy the disadvantages of the conventional steel shaft such as heavy weight and low elasticity, but it is not certain whether the high strength can be maintained and whether the torque can be sufficiently prevented.

### Technical Problems

At the time of golf swing with a graphite-shafted club, power will be accumulated on the shaft as the shaft is bending. When the bent shaft is restored to its original shape, its accumulated power is released and the club head speeds up faster. There is a point so-called a kick point in the graphite-shafted club, which refers to the bent portion of the shaft when the impact is made. This kick point plays an important role in determining the flight distance and the trajectory of the golf ball after impact. The higher the kick point on the shaft is, the farther and the lower the golf ball flies. On the other hand, the lower the kick point is, the shorter and the higher the ball flies.

Because the conventional graphite shaft is hollow through its entire length including the portion where the grip is installed, the portion from the proximal end of the shaft to the kick point is also bent at the time of swing, and it becomes a very unstable factor in the directivity and the trajectory of a golf ball.

In order to solve this problem, there have been attempts to improve the stability in golf swing by filling the shaft with various materials from the distal end to the point just before the grip is installed and reinforcing the shaft. However, the weight of the whole golf club had to increase because of the weight of the filler, which resulted in breaking the balance of the shaft. As a solution to such an imbalance, the weight of the golf club head needed to be reduced, but that brought another unfavorable problem.

### SUMMARY OF THE INVENTION

Therefore, it is an object of the present invention to provide a method of producing a graphite shaft, a part of which is reinforced by a filler to improve the performance of a golf club, a lure fishing rod or the like.

According to an aspect of the present invention, a method of producing a graphite shaft is provided which comprises the steps of: preparing a synthetic resin tube into which thermosetting resin powder is charged; inserting the synthetic resin tube into a hollow graphite shaft; sealing a proximal end of the graphite shaft; and heating the graphite shaft in a high-temperature pressurizing apparatus to have the thermosetting resin powder foamed for filling a part of the graphite shaft.

The graphite shaft produced according to the method of the present invention can be used as the shaft of a golf club or the shaft of a lure fishing rod.

Preferably, the thermosetting resin powder is foamed in all or a portion of a section from the midpoint of the grip to the midpoint of the entire graphite shaft.

Advantageously, the method further comprises forming micro-perforations in the distal end of the synthetic resin tube prior to the synthetic resin tube is inserted into the hollow graphite shaft.

Preferably, the method further comprises forming thin films on both ends of the foamed thermosetting resin by applying polymer resin adhesive after heating the shaft.

### Effects of the Invention

According to the present invention, in case the method is used for producing a shaft of a golf club, all or a portion of the section from the midpoint of the grip to the vicinity of the midpoint of the entire length of the shaft is reinforced by a filler, and hence, the shaft will not be bent through its entire length. Because a part of the shaft from the distal end of the foamed filler to the portion to which the head is attached still remains hollow, the trajectory, flight distance and the directivity of a golf ball after impact can be improved as compared to the shaft without such reinforcement.

In addition, according to the present invention, since the filler reinforces all or a part of the shaft from the midpoint of the grip to the vicinity of the midpoint of the entire length of the shaft, the torque of the shaft can be greatly reduced as compared to the shaft before reinforcement.

### BRIEF DESCRIPTIONS OF THE DRAWINGS

FIG. 1 shows a driver, the longest club among the golf clubs;

FIG. 2 shows a hollow graphite shaft, and

FIG. 3 is a view showing the state in which thermosetting resin powder in a synthetic resin tube is foamed in a hollow graphite shaft, for which the method of the present invention is used to produce a graphite shaft of a golf club.

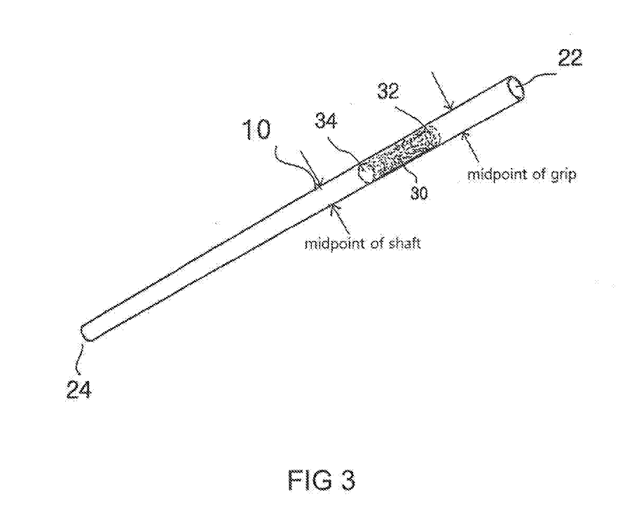

### BEST MODE OF THE INVENTION

A hollow graphite shaft to be used in the method of the present invention is produced through the following steps:
1) A prepreg is prepared from yam-shaped carbon fibers and epoxy resin is impregnated (deeply penetrated) to produce a graphite sheet.
2) The graphite sheet is cut to a desired length of a golf club.
3) The graphite sheet is wound on a metal bar called a mandrel.
4) Tape is put on the graphite sheet on a mandrel for preventing deformation of its shape during the next heating process.
5) The mandrel is now put into a heating furnace and hardened. The heating process is carried out at around 80° C. for 30 minutes and at 130° C. for about an hour.
6) Tape is removed from the shaft after the heating process.

The method of the present invention uses the hollow graphite shaft produced by the above process. The inventive concept of the present invention is that a part of the section from the midpoint of the grip to the vicinity of the midpoint of the entire length of the hollow graphite shaft is filled with thermosetting resin powder, and the shaft filled with the resin powder is heated to have the resin powder foamed in a state in which equilibrium pressure is established by applying isotropic pressure from the outside of the shaft in an autoclave. By doing so, a part of the shaft from the midpoint of the grip to the vicinity of the midpoint of the entire length of the shaft can be reinforced by the foamed thermosetting resin.

The method according to the present invention comprises the steps of preparing a synthetic resin tube into which thermosetting resin powder is charged; inserting the synthetic resin tube into a hollow graphite shaft; sealing a proximal end of the graphite shaft; and heating the graphite shaft in a high-temperature pressurizing apparatus to foam the thermosetting resin powder to fill a part of the graphite shaft.

According to the present invention, a method for producing a graphite shaft to be used with other products, such as a lure fishing rod, is also provided in the same manner as described above.

### DETAILED DESCRIPTIONS OF THE INVENTION

A method for producing a graphite shaft according to the present invention will be described in detail with reference to the accompanying drawings.

In the following description, a method for producing a graphite shaft of a golf club is explained for the purpose of simplicity, but it will be obvious to a person with ordinary skill in the art that the concept of the present invention should not be limited to the use with golf clubs only.

Hence, it should be understood that the method according to the present invention can be equally applied to graphite shafts that can be used with other sports equipment and daily necessities.

In the following description, the “proximal end portion” of a shaft means an end portion of the shaft of a golf club or a lure fishing rod where the grip is mounted, namely, an end portion near to the user. Further, the “distal end portion” of a shaft is the end portion located on the opposite side to the proximal end portion, which means an end portion far from the user.

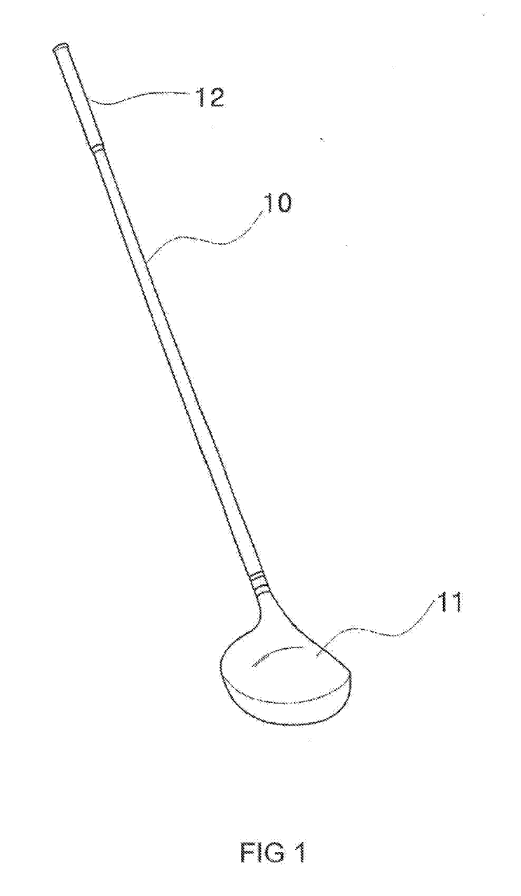

FIG. 1 shows a driver which is the longest one among golf clubs. The driver includes a club head 11 hitting a golf ball, a shaft 10 for fixing the club head 11, and a grip 12.

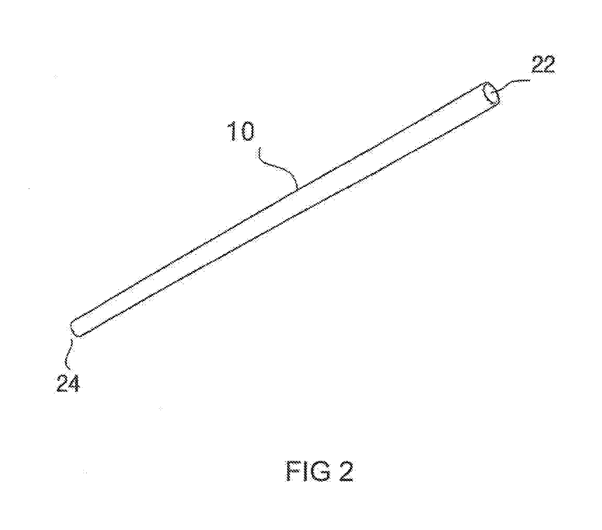

FIG. 2 is a view showing a hollow graphite shaft for a golf club. In both end portions of the graphite shaft, the grip is mounted on the proximal end portion 22, and the club head is attached to the distal end portion 23 having a smaller diameter than that of the proximal end portion 22.

A hollow graphite shaft to be used in the method of the present invention is produced through the following steps:
1) A prepreg is prepared from yam-shaped carbon fibers and epoxy resin is impregnated (deeply penetrated) to produce a graphite sheet.
2) The graphite sheet is cut to a desired length of a golf club.
3) The graphite sheet is wound on a metal bar called a mandrel.
4) Tape is put on the graphite sheet on a mandrel for preventing deformation of its shape during the next heating process.
5) The mandrel is now put into a heating furnace and hardened. The heating process is carried out at around 80° C. for 30 minutes and at 130° C. for about an hour.
6) Tape is removed from the shaft after the heating process.

The method of the present invention uses the hollow graphite shaft produced as above. According to the present invention, the section from the midpoint of the grip to the vicinity of the midpoint of the entire length of the hollow graphite shaft is filled with thermosetting resin powder (“filler”), and the shaft filled with the filler is heated in a high-temperature pressurizing apparatus to have the filler foamed, so that the section from the midpoint of the grip to the vicinity of the midpoint of the entire length of the shaft is reinforced by the foamed thermosetting resin.

In the first step of the method of the present invention, a synthetic resin tube 30 in which thermosetting resin powder is charged is prepared. The synthetic resin tube 30 such as a nylon tube has a length corresponding to the length of a section from the midpoint of the grip to the vicinity of the midpoint of the entire length of the shaft. The tube is then filled with thermosetting resin powder after sealing the grip-side end portion 32 of the tube 30. The “grip-side end portion” means the end portion near to the user, and the “head-side end portion” means the opposite end portion thereof.

Thermosetting resin powder has a feature of very light in weight, and is foamed at a specific temperature to expand in volume when it is heated. Therefore, in the step of charging the thermosetting resin powder into the tube, an appropriate amount should be filled in consideration of the expanded volume of the thermosetting resin powder.

It is also important that the thermosetting resin powder is placed evenly along the entire length of the tube.

In order to allow the air to get out of the tube 30 during the foaming process, it is also desirable to form micro-perforations in the head-side end portion 34 of the tube 30 before the tube is inserted into the hollow graphite shaft. The micro-perforations may be formed manually by making holes in the head-side end portion of the tube, but not limited thereto.

After charging the tube 30 with the thermosetting resin, the tube 30 is inserted into the hollow graphite shaft. Although one synthetic resin tube is shown in the drawing, a plurality of tubes may be inserted according to its thickness and diameter.

After inserting the tube 30 into the hollow graphite shaft 10 as described above, the proximal end 22 of the graphite shaft 10 is sealed by, for example, covering the proximal end portion 22 using tape or the like.

The graphite shaft 10 is then placed in a high-temperature pressurizing apparatus, for example, an autoclave, and then the graphite shaft is subjected to a heat treatment.

The autoclave generally refers to a hot-pressing sterilizer used in the microbiology field using high temperature and high pressure steam, which is used for sterilizing or disinfecting various experimental equipments, waste materials, fiber materials and media. It can also refer to a container or a system which can withstand the reactions that occur in high temperature and high pressure. An autoclave applies isotropic pressure to a material inside, and it can control the material to be formed at a certain pressure and temperature determined by a user. The autoclave is a general device known in the relevant art.

As described above, thermosetting resin powder is charged into the synthetic resin tube, the tube is inserted into the hollow graphite shaft, the graphite shaft is placed in an autoclave, and the heat treatment is performed.

The reason why the heat treatment should be performed under a pressurized condition in the present invention is as follows:

If the graphite shaft is heated without pressure, a proper foaming of the thermosetting resin powder having been charged into the synthetic resin tube inside the graphite shaft will not occur because a proper pressure is required for the thermosetting resin powder to be foamed.

That is, since the graphite shaft is made by rolling a graphite sheet to multiple layers, the graphite shaft itself cannot apply pressure on the thermosetting resin powder when the thermosetting resin powder is heated and foamed. Therefore, the shaft should be placed in an autoclave which can apply isotropic pressure to the shaft, and the resin powder is heated to be foamed.

As the length of the synthetic resin tube 30 corresponds to the length of the section from the midpoint of the grip to the vicinity of the midpoint of the entire length of the shaft where all or a part of the section will be filled with filler, the thermosetting resin powder subjected to the heat treatment in the tube is foamed in order to completely fill all or a part of the section from the midpoint of the grip to the vicinity of the midpoint of the entire length of the shaft.

When the heat treatment of the shaft is completed, a part of the foamed thermosetting resin could be left poking out of the proximal end portion 22 of the shaft. Using proper treatment, the poking portion could be removed from the vicinity of the proximal end.

Further, after the heat treatment of the shaft is completed, end portions of the foamed resin can be exposed outside both ends of the synthetic tube, which can result in the deformation of the golf club during the future use. Hence, to protect the ends of the foamed resin, it is preferable to have thin films formed on the foamed resin by applying a polymer adhesive through the proximal end and/or the distal end of the shaft.

After the above processes, the grip and the head are attached to the shaft, and a golf club having a graphite shaft produced according to the method of the present invention is completed.

While the present invention has been shown and described with reference to the exemplary embodiments only, it is to be understood that the invention is not limited to the disclosed exemplary embodiments. Accordingly, these changes and modifications should be construed as being included within the scope of the appended claims.

### INDUSTRIAL APPLICABILITY

As the graphite shaft produced according to the present invention has an improved strength, the shaft has a wider industrial applicability to, but not limited to, golf clubs and lure fishing rods.

1. A method for producing a graphite shaft, which comprises the steps of:
preparing a synthetic resin tube into which thermosetting resin powder is charged;
forming micro-perforations in the distal end of the synthetic resin tube;
inserting the synthetic resin tube having said micro-perforations into a hollow graphite shaft;
sealing a proximal end of the graphite shaft; and
heating the graphite shaft in a high-temperature pressurizing apparatus to foam the thermosetting resin powder for filling a part of the graphite shaft.

2. The method according to claim 1, wherein the graphite shaft is used as the shaft of a golf club.

3. The method according to claim 1, wherein the graphite shaft is used as the shaft of a lure fishing rod.

4. The method according to claim 2, wherein said thermosetting resin powder is foamed in all or a portion of a section from the midpoint of the grip to the midpoint of the entire graphite shaft.

5. (canceled)

6. The method according to claim 1, wherein the method further comprises a step of forming thin films on both ends of the foamed thermosetting resin by applying polymer resin adhesive after heating the shaft.

7. The method according to claim 1, wherein said high-temperature pressurizing apparatus is an autoclave.
